(19) United States
(12) Patent Application Publication
(10) Pub. No.: US 2010/0314593 A1
(43) Pub. Date: Dec. 16, 2010

(54) Adjustable Pry Bar

(76) Inventor: Chen Jun Fan, Taichung City (TW)

Correspondence Address: CHEN JUN FAN, 5F.-2, No. 212, Sec. 1, Wunsin Rd.,, Taichung City, 408, TW

(21) Appl. No.: 12/459,222

(22) Filed: Jun. 30, 2009

(30) Foreign Application Priority Data
Jun. 11, 2009 (TW) 098210379

(51) Int. Cl. B66F 15/00

(52) U.S. Cl. 254/25

(57) ABSTRACT

An adjustable pry bar comprises a prying block used to pry and remove an object and including first and second side wings mounted on a rear end thereof and parallel to each other to clamp a head end of a handle, the first side wing including a groove to receive multiple balls and biasing members; an adjusting mechanism installed in a central aperture and a notch of the head end and including a plurality of biasing members and balls, a shaft member, and a control member, the biasing member being flexible to be pushed backward to abut against the balls, the shaft member including a first end for engagement with the balls, the first end including a recess arranged around an outer rim thereof, the shaft member also including a second end extending out of a second through hole of the second side wing to coupled with the control member.

### BACKGROUND OF THE INVENTION

1. Field of the Invention

The present invention relates to hand tool, and more particularly to an adjustable pry bar.

2. Description of the Prior Art

Conventional pry bat are used in vehicle maintenance or mechanical repairs process, however an angle between the prying block and the handle can not be adjusted randomly in different working space.

The present invention has arisen to mitigate and/or obviate the afore-described disadvantages.

### SUMMARY OF THE INVENTION

The primary object of the present invention is to provide an adjustable pry bar which can adjust the angle of the prying block easily.

Another object of the present invention is to provide an adjustable pry bar which can be uses as a hammer as well.

An adjustable pry bar according to the present invention comprises:

a prying block including a hook disposed on a front end thereof to pry and remove an object, and including a first and a second side wings mounted on a rear end thereof and being parallel to each other, the first and the second side wings including a first and a second through holes fixed on central portions thereof respectively, the first side wing including a groove arranged on an internal end surface thereof to communicate with the first through hole;

a handle including a head end defined on a front end thereof to be axially coupled between the first and the second side wings, the head end including a central aperture with a smaller diameter and a notch with a larger diameter, both of which are in communication with each other, and a distal end of the handle being used to be held by a user;

an adjusting mechanism installed in the central aperture and the notch of the head end of the handle and comprised of multiple biasing members, a number of balls, a shaft member, and a control member, the biasing member being flexible to be pushed backward to abut against the balls, and the shaft member including a first end for engagement with the balls, the first end including a recess arranged around an outer rim thereof, the shaft member also including a second end extending out of the second through hole of the second side wing to coupled with the control member;

wherein the groove of the prying block includes three radially extending ends, each having a positioning portion and a receiving chamber proximate to the positioning portion, the balls of the adjusting mechanism are received in the positioning portions and the biasing members are retained in the receiving chambers;

wherein the notch includes a hexagonal opening formed therein, and the shaft member includes a hexagonal bolt segment located between the first and the second ends so as to retain in the notch to axially move without rotation, the adjusting mechanism includes a spring fitted to the first end of the shaft member to bias against the bolt segment and an inner wall of the notch; the second end of the shaft member inserts through a hollow covering member to cover the second through hole of the second side wing;

wherein the biasing member includes a clamping extension, a central portion extending from one side of the clamping extension, and two contacting ribs extending from the central portion so that the contacting ribs have a flexibility relative to the clamping extension, the biasing member further includes a cavity defined between the two contacting ribs to contact with the ball;

wherein the handle includes a hammer and a cone-shaped member, both of which are screwed to the head end individually;

wherein the handle includes a tip stem disposed at a distal end thereof opposite to the head end, the tip stem includes outer threads formed thereon so as to fit a sleeve, the sleeve includes a cutout disposed therein and having inner threads arranged in the cutout so that the tip stem is inserted in the cutout to be screwed with the sleeve by ways of the outer and inner threads.

### BRIEF DESCRIPTION OF THE DRAWINGS

FIG. 1 is a perspective view showing the exploded components of an adjustable pry bar in accordance with a first embodiment of the present invention;

FIG. 2 is a plan view of a prying block of the adjustable pry bar in accordance with the first embodiment of the present invention;

FIG. 3 is a perspective view of a biasing member of the adjustable pry bar in accordance with the first embodiment of the present invention;

FIG. 4 is a cross sectional view showing the operation of the adjustable pry bar in accordance with the first embodiment of the present invention;

FIG. 5 is another cross sectional view showing the operation of the, adjustable pry bar in accordance with the first embodiment of the present invention;

FIG. 6 is a top plan view showing the operation of the adjustable pry bar in accordance with the first embodiment of the present invention;

FIG. 7 is another top plan view showing the operation of the adjustable pry bar in accordance with the first embodiment of the present invention;

FIG. 8 is a perspective view of an adjustable pry bar in accordance with a second embodiment of the present invention;

FIG. 9 is a perspective view showing the exploded components of the adjustable pry bar in accordance with the second embodiment of the present invention;

FIG. 10 is a top plan view of FIG. 9; and

FIG. 11 is a top plan view of an adjustable pry bar in accordance with a third embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

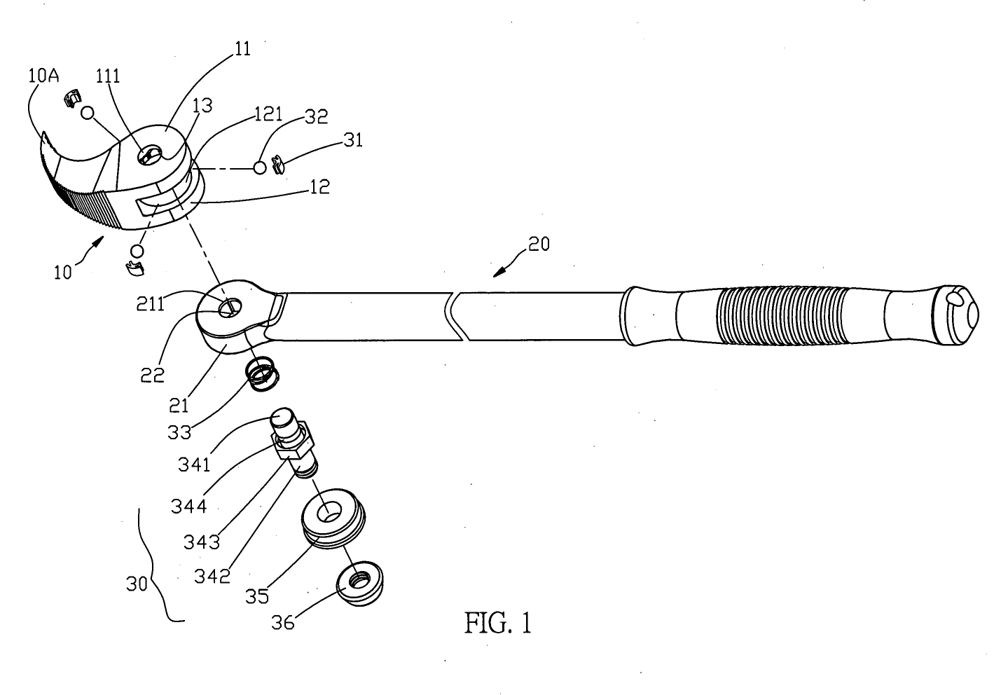

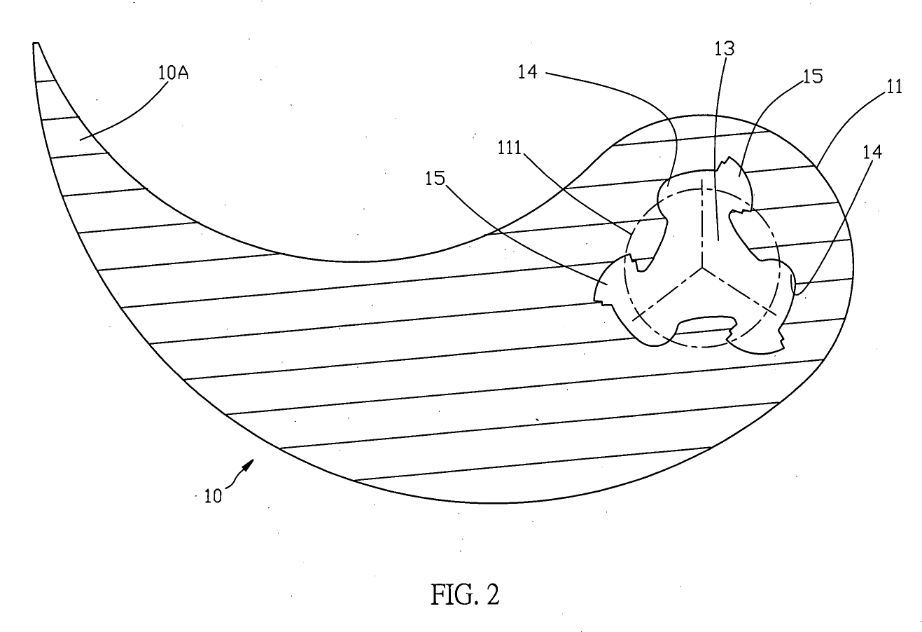

Referring to FIG. 1, an adjustable pry bar in accordance with a first embodiment of the present invention comprises: a prying block 10, a handle 20, an adjusting mechanism 30, wherein

the prying block 10 is formed in an upward-extending tip shape and includes a hook 10A disposed on a front end thereof to pry and remove an object, and includes a first and a second side wings 11, 12 mounted on a rear end thereof and being parallel to each other, the first and the second side wings 11, 12 include a first and a second through holes 111, 112 fixed on central portions thereof respectively, the first side wing 11 includes a groove 13 arranged on an internal end surface thereof to communicate with the first through hole 111, the groove 13 includes three radially extending ends, each having a positioning portion 14 and a receiving chamber 15 proximate to the positioning portion 14;

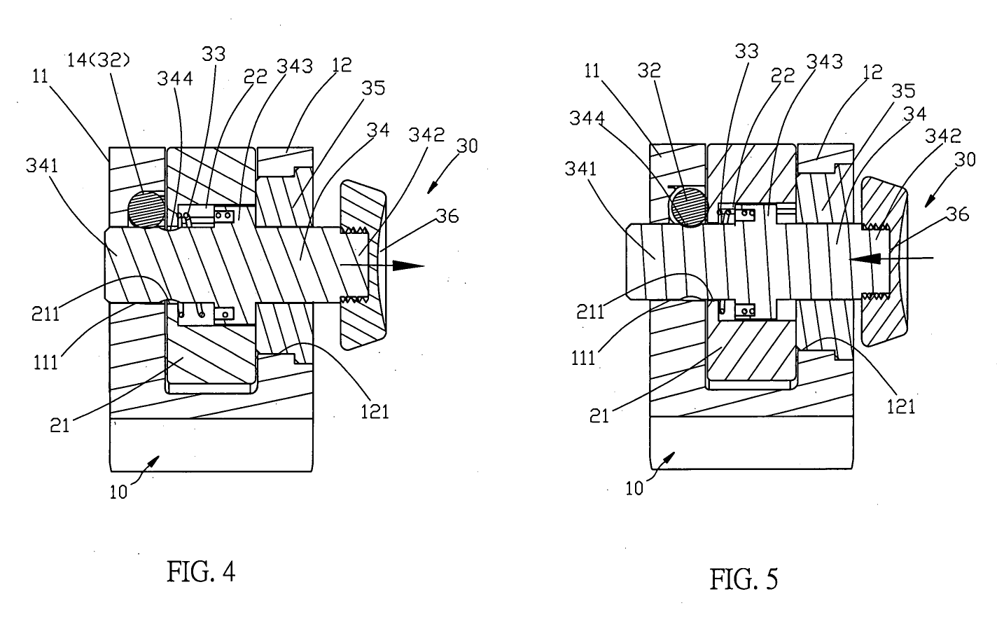

the handle 20 as illustrated in FIGS. 1 and 4, includes a head end 21 defined on a front end thereof to be axially coupled between the first and the second side wings 11, 12, the head end 21 includes a central aperture 211 with a smaller diameter and a notch 22 with a larger diameter, both of which are in communication with each other, the notch 22 includes a hexagonal opening formed therein, such that the central aperture 211 is in response to the first through hole 111 and the notch 22 is in response to the second through hole 121, and a distal end of the handle 20 is formed in an anti-slip pattern or sleeve manner so as to be held securely by a user;

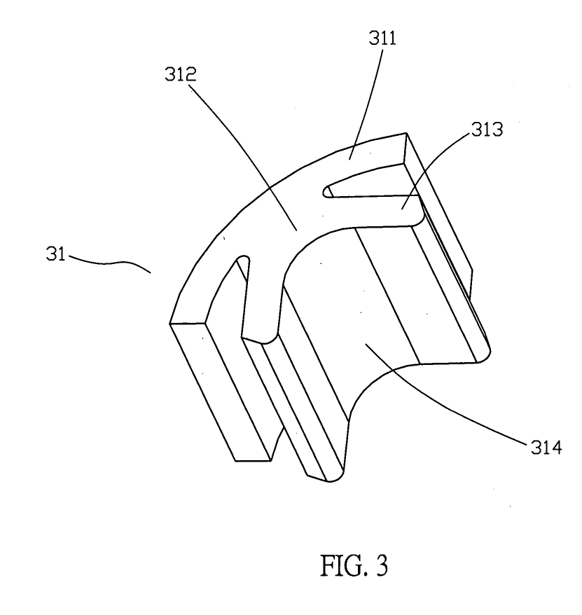

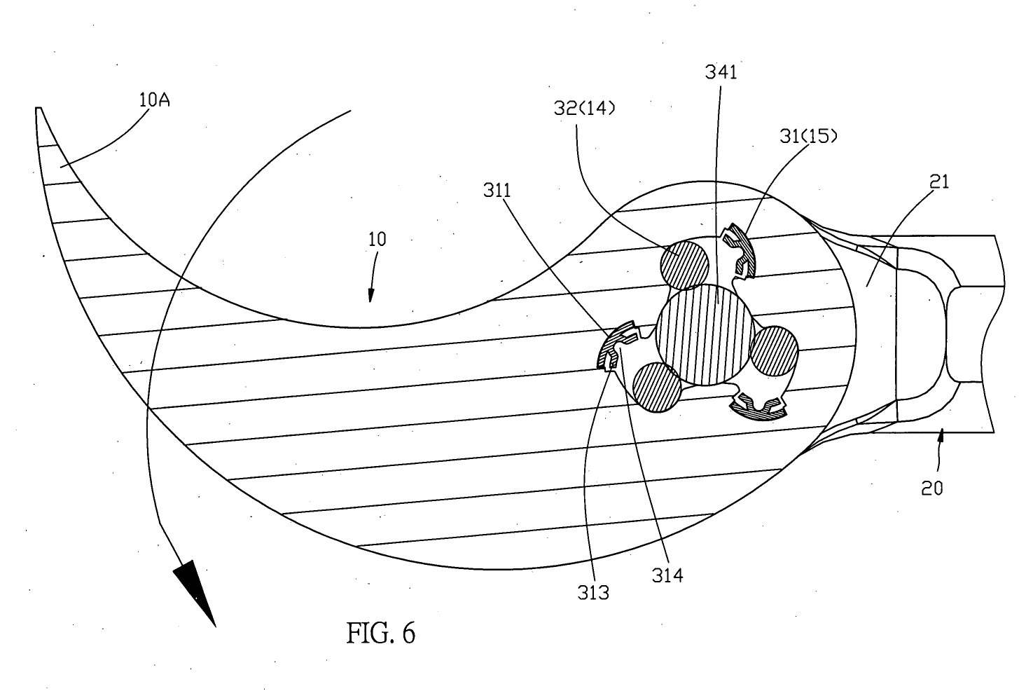

the adjusting mechanism 30 is installed in the central aperture 211 and the notch 22 of the head end 21 of the handle 20 and comprised of three biasing members 31, three balls 32, a spring 33, a shaft member 34, a covering member 35, and a control member 36. Referring to FIGS. 3 and 6, the biasing member 31 is flexible to be pushed backward to abut against the balls 32 which are located in the positioning portions 14, and the biasing members 31 are retained in the receiving chambers 15 of the first side wing 11 and each includes a clamping extension 311, a central portion 312 extending from one side of the clamping extension 311, and two contacting ribs 313 extending from the central portion 312 so that the contacting ribs 313 have a flexibility relative to the clamping extension 311, the biasing member 31 further includes a cavity 314 defined between the two contacting ribs 313 to contact with the ball 32.

With reference to FIGS. 1 and 4, the spring 33 is received in the notch 22 to bias against an inner wall of the central aperture 211, and the shaft member 34 includes a first end 341, a second end 342, a hexagonal bolt segment 343 located between the first and the second ends 341, 342 so as to retain in the notch 22 to axially move without rotation, the first end 341 includes a recess 344 arranged around an outer rim thereof so that the spring 33 is fitted to the shaft member 34 by using the first end 341 and the shaft member 34 is inserted through the second through hole 121, the notch 22, and the central aperture 211. In addition, the recess 344 is response to the ball 32, and the spring 33 contacts with the notch 22, therefore the shaft member 34 displaces axially along the notch 22 to compress or uncompress the spring 33.

The second end 342 extends out of the second through hole 121 so that the hollow covering member 35 fits to the second end 342 and to cover the second through hole 121, and the second end 342 screws with the control member 36.

In operation, as shown in FIGS. 4-7, the prying block 10 is rotated in an anticlockwise direction to guide the balls 32 to be located in the positioning portions 14 and leave away the biasing member 31 from a certain distance, such that the balls 32 are biased against an outer side surface of the first end 341 of the shaft member 34, thus engaging the prying block 10 at any angles securely.

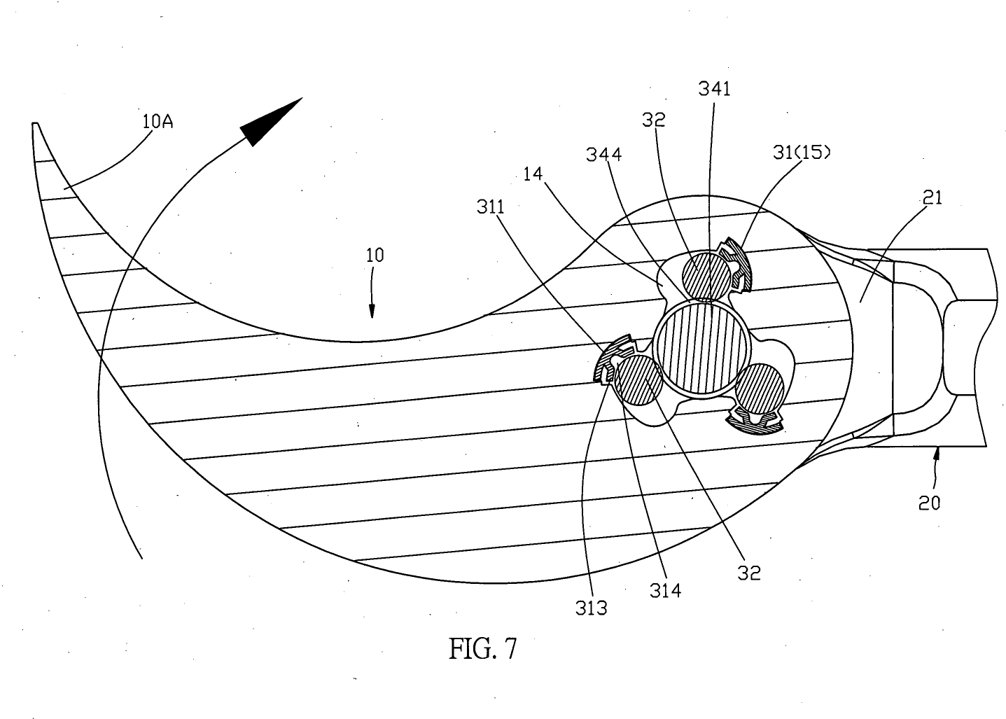

On the contrary, as illustrated in FIGS. 5 and 7, as the control member 36 is pressed, the bolt segment 343 of the shaft member 34 moves along the notch 22 to push the spring 33 so that the recess 344 receive-the balls 32 to disengage from the first end 341 and move close to the biasing member 31. In the meantime, the prying block 10 is rotated in a clockwise direction to adjust it working angle by using shaft member 34 as its pivot point, thereby adjusting the prying block 10.

Thereafter, the control member 36 is released so that the spring 33 pushes the bolt segment 343 to move in an opposite direction along the notch 22 and to force the balls 32 to disengage from the recess 344 of the shaft member 34 simultaneously, and the contacting ribs 313 of the biasing member 31 push the ball 32 adversely to move into the positioning portions 14, engaging the first end 341 again to position the prying block 10.

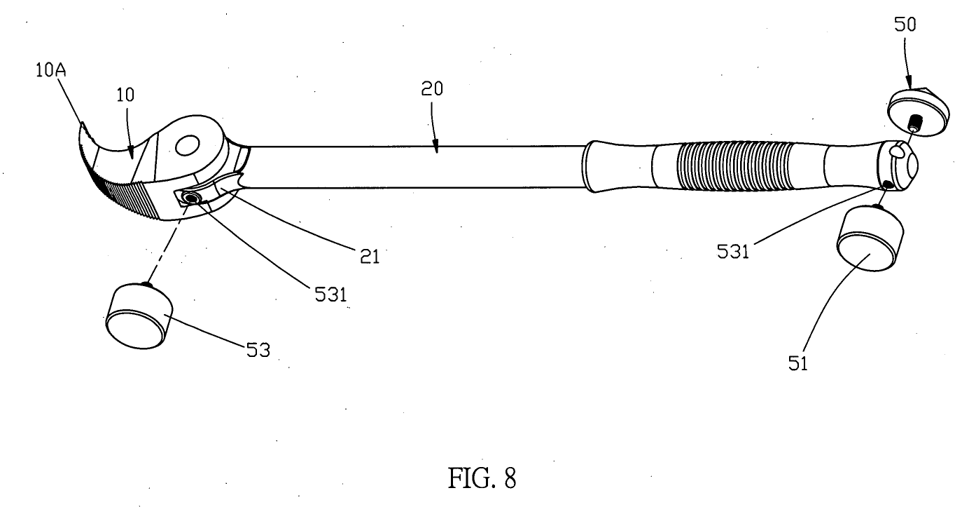

With reference to FIG. 8, an adjustable pry bar in accordance with a second embodiment of the present invention comprises a handle 20 including two screw bore 531 disposed on two sides of a distal end thereof individually to screw with a cone-shaped member 50, and a first hammer 51. An outer side of the head end 21 also screws with a second hammer 53. In operation, the second hammer 53 is disengaged from the head end 21, however as desiring to hammer an object, the second hammer 53 is screwed with and a screw bore 531 of the head end 21, and as desiring to pry something else, the cone-shaped member 50 is screwed into the screw bore 531 of the distal end of the handle 20, obtaining hammering and prying purposes.

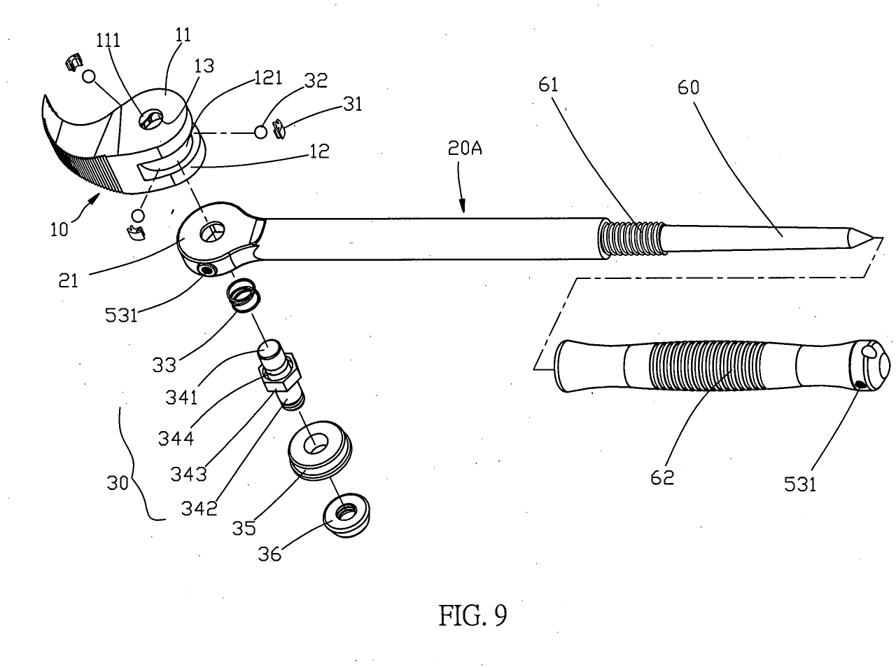

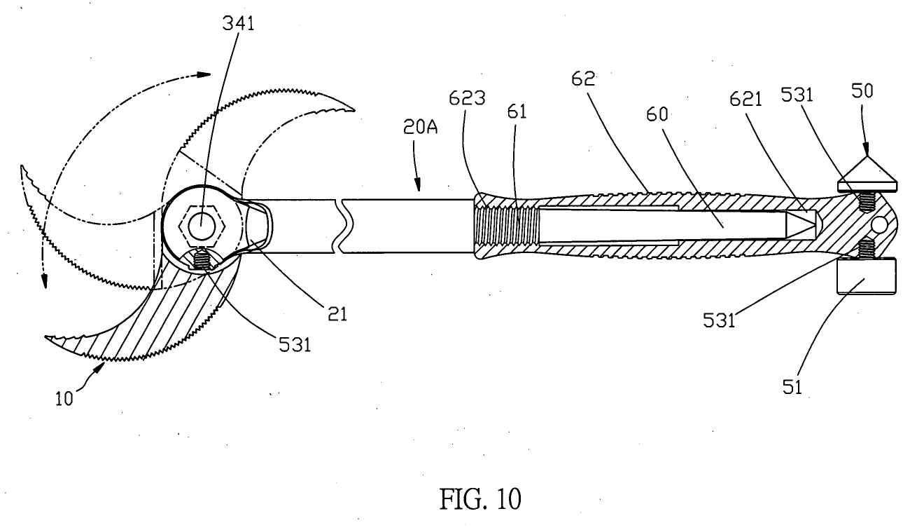

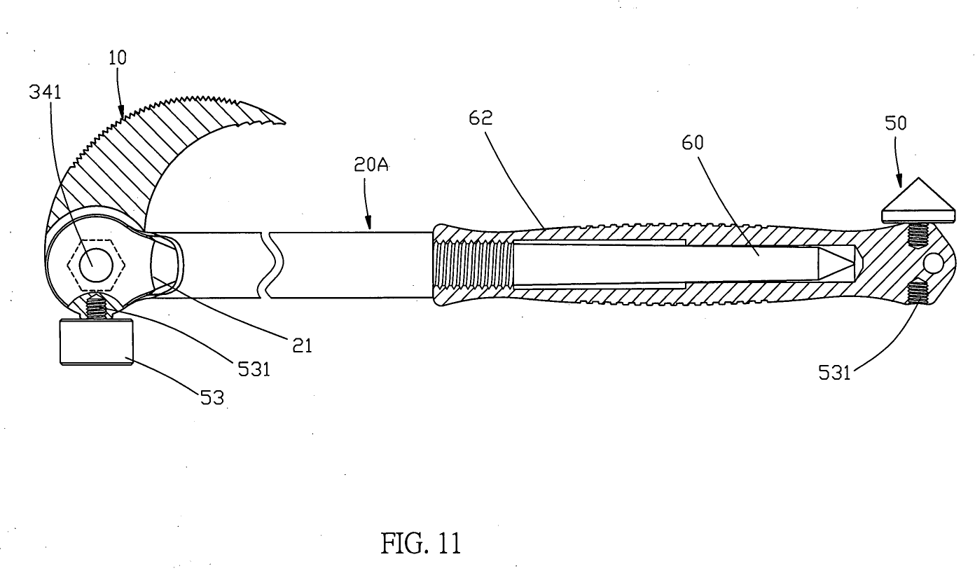

Referring to FIGS. 9-11, an adjustable pry bar in accordance with a third embodiment of the present invention comprises a handle 20A with a tip stem 60, the tip stem 60 includes outer threads 61 formed thereon so as to fit a sleeve 62, the sleeve 62 includes a cutout 621 disposed therein and having inner threads 623 arranged in the cutout 621 so that the tip stem 60 is inserted in the cutout 621 to be screwed with the sleeve 62 by ways of the outer and inner threads 61, 623. In operation, the sleeve 62 is disengaged from the tip stem 60 so that the tip stem 60 is used to knock and impact an object on a spot. As illustrated in FIG. 11, the handle 20A includes a hammer 53 and a cone-shaped member 50, both of which are screwed to the head end 2-1 individually.

While we have shown and described various embodiments in accordance with the present invention, it is clear to those skilled in the art that further embodiments may be made without departing from the scope of the present invention.

What is claimed is:

1. An adjustable pry bar comprising:
a prying block including a hook disposed on a front end thereof to pry and remove an object, and including a first and a second side wings mounted on a rear end thereof and being parallel to each other, the first and the second side wings including a first and a second through holes fixed on central portions thereof respectively, the first side wing including a groove arranged on an internal end surface thereof to communicate with the first through hole;
a handle including a head end defined on a front end thereof to be axially coupled between the first and the second side wings, the head end including a central aperture with a smaller diameter and a notch with a larger diameter, both of which are in communication with each other, and a distal end of the handle being used to be held by a user;
an adjusting mechanism installed in the central aperture and the notch of the head end of the handle and comprised of multiple biasing members, a number of balls, a shaft member, and a control member, the biasing member being flexible to be pushed backward to abut against the balls, and the shaft member including a first end for engagement with the balls, the first end including a recess arranged around an outer rim thereof, the shaft member also including a second end extending out of the second through hole of the second side wing to coupled with the control member.

2. The adjustable pry bar as claimed in claim 1, wherein the groove of the prying block includes three radially extending ends, each having a positioning portion and a receiving chamber proximate to the positioning portion, the balls of the adjusting mechanism are received in the positioning portions and the biasing members are retained in the receiving chambers.

3. The adjustable pry bar as claimed in claim 1, wherein the notch includes a hexagonal opening formed therein, and the shaft member includes a hexagonal bolt segment located between the first and the second ends so as to retain in the notch to axially move without rotation, the adjusting mechanism includes a spring fitted to the first end of the shaft member to bias against the bolt segment and an inner wall of the notch; the second end of the shaft member inserts through a hollow covering member to cover the second through hole of the second side wing.

4. The adjustable pry bar as claimed in claim 1, wherein the biasing member includes a clamping extension, a central portion extending from one side of the clamping extension, and two contacting ribs extending from the central portion so that the contacting ribs have a flexibility relative to the clamping extension, the biasing member further includes a cavity defined between the two contacting ribs to contact with the ball.

5. The adjustable pry bar as claimed in claim 1, wherein the handle includes a hammer and a cone-shaped member, both of which are screwed to the head end individually.

6. The rack assembly as claimed in claim 1, wherein the handle includes a tip stem disposed at a distal end thereof opposite to the head end, the tip stem includes outer threads formed thereon so as to fit a sleeve, the sleeve includes a cutout disposed therein and having inner threads arranged in the cutout so that the tip stem is inserted in the cutout to be screwed with the sleeve by ways of the outer and inner threads.
